(19) United States
(12) Patent Application Publication
(10) Pub. No.: US 2026/0052098 A1
(43) Pub. Date: Feb. 19, 2026

(54) SYSTEMS AND METHODS FOR DYNAMIC ROUTING PROTOCOLS

(71) Applicant: Wells Fargo Bank, N.A., San Francisco, CA (US)

(72) Inventors: Peter Burton Bordow, Fountain Hills, AZ (US); Michael Erik Meinholz, Charlotte, NC (US); Abhijit Rao, Irvine, CA (US); Bradford A. Shea, Mint Hill, NC (US); Jeff J. Stapleton, Fort Worth, TX (US)

(21) Appl. No.: 18/806,052

(22) Filed: Aug. 15, 2024

(51) Int. Cl. H04L 45/24; H04L 41/16; H04L 45/121

(52) U.S. Cl. CPC H04L 45/24; H04L 45/121; H04L 41/16

(57) ABSTRACT

Systems and methods for dynamic routing protocols are provided. A method includes receiving, using a computer system including a quantum computer, data related to a multipoint communication between a start point and an end point from one or more data sources, and calculating one or more routes for the multipoint communication between the start point and the end point using the data and based at least in part on a shortest route between the start point and the end point. Using the quantum computer, the one or more routes are optimized based on a communication status of one or more nodes along the route. The optimized routes are dynamically selected based on timing and performance requirements of the computer system, and the multipoint communication between the start point and the end point is executed using the optimized one or more routes.

### TECHNICAL FIELD

This document relates generally to computer systems and more particularly to systems and methods for dynamic routing protocols.

### BACKGROUND

Communications between points or nodes in a communication system may encounter interruptions or interference due to a number of dynamic variables. Due to the dynamic nature of these variables, an optimum route of communications between a given pair of points or nodes may be different at different time periods because of the resulting interruptions or interference, traffic at intermediate nodes, or other factors. One type of communications susceptible to dynamic interference is communications to or from a satellite. Satellite communications may include communications between satellites, between a terrestrial-based device (e.g., a ground station, a vehicle, etc.) and a satellite, between a plane or other aerial vehicle and a satellite, or the like. Improved systems and methods for dynamic routing protocols for communications are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a block diagram of an example of an environment including a system for communicating with spaceborne satellites and other airborne aircraft, according to various embodiments;

FIG. 2 illustrates an exemplary infrastructure for use in the subject matter, according to various embodiments;

FIG. 3 illustrates an example machine learning module for dynamic routing protocols, according to various embodiments;

FIG. 4 illustrates a flowchart of a method of updating a model for dynamic routing protocols, according to various embodiments;

FIG. 5 illustrates an example embodiment of a method for optimizing dynamic routing protocols, according to various embodiments;

FIG. 6 illustrates a block diagram showing a node communication path, according to various embodiments;

FIG. 7 illustrates example circuitry in a node, according to various embodiments; and

FIG. 8 is a block diagram of a machine in the example form of a computer system within which a set of instructions may be executed, for causing the machine to perform any one or more of the methodologies discussed herein.

### DETAILED DESCRIPTION

The following detailed description of the subject matter refers to subject matter in the accompanying drawings which show, by way of illustration, specific aspects and embodiments in which the subject matter may be practiced. These embodiments are described in sufficient detail to enable those skilled in the art to practice the subject matter. References to “an”, “one”, or “various” embodiments in this disclosure are not necessarily to the same embodiment, and such references contemplate more than one embodiment. The following detailed description is demonstrative and not to be taken in a limiting sense. The scope of the subject matter is defined by the appended claims, along with the full scope of legal equivalents to which such claims are entitled.

The systems and techniques described herein provide a dynamic routing protocol for wireless communications. In various examples, the provided routing protocol dynamically determines a communication route in a multi-point or multi-node communication network, such as a mesh network, and optimizes the route using quantum computing. In one example, the dynamic routing protocol is used to avoid obstructions in space, for example for communicating to or from a satellite. The obstructions may include space debris, satellites, or other obstructions that may interfere with a communication, such as an aurora, solar rays, etc. Communications may include communications between satellites, between a terrestrial-based device (e.g., a ground station, a vehicle, etc.) and a satellite, between a plane or other aerial vehicle and a satellite, or the like.

As described herein, a satellite is a human-made object deliberately placed into orbit around celestial bodies, such as Earth, to serve various scientific, technological, or communication purposes. Satellites are generally launched into space via rockets and positioned into one of several possible orbits. Earth orbits generally are either geostationary—where the artificial satellite remains over a fixed point—or non-geostationary. Non-geostationary orbits can include low-Earth orbit (LEO), medium-Earth orbit (MEO), and high-Earth orbit (HEO).

Satellites and aircraft are often equipped with systems for power generation (e.g., solar panels), communication mechanisms (e.g., antennas, transponders, etc.), and computers for control or data processing. Satellites are used in communications, weather forecasting, navigation systems—such as the Global Positioning System (GPS)—astronomical observations, or Earth observation. Earth observation may include such activities as environmental monitoring or scientific research.

The techniques discussed herein may be used with any type of point-to-point or node-to-node communication. In one example, communication with a LEO satellite or satellites is contemplated. A LEO satellite typically refers to a satellite orbiting between 500 to 2,000 kilometers above Earth, including in groups of satellites known as a satellite constellation. However, other types of satellite networks and satellite network communications may be used with the subject matter. Other types of satellite networks may involve geosynchronous orbit (GEO) satellite networks (e.g., orbiting at approximately 35,786 kilometers but synchronized with the rotation of the earth), MEO satellite networks (e.g., orbiting between 2,000 to 36,000 kilometers above Earth) or HEO satellite networks (e.g., orbiting more than 36,000 kilometers above earth). The term “non-terrestrial” or “satellite” is generally used in this document to refer to a space location or entity, whereas the term “terrestrial” or “ground” is generally used in this document to refer to an Earth location or entity. Terrestrial locations may include fixed or mobile stations, computing units of different form factors such as servers and virtual machines, including but not limited to mobile locations provided by planes, trains, ships that are moveable among different geographic sectors and coverage areas.

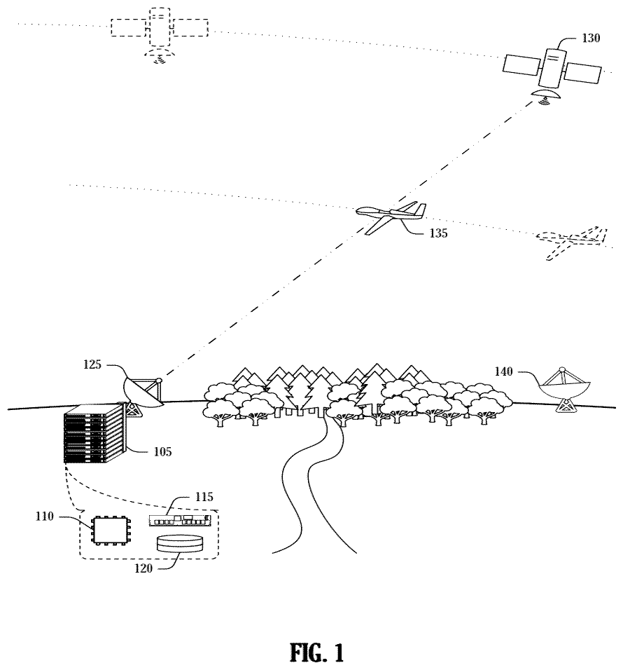

FIG. 1 is a block diagram of an example of an environment including a system 105 for communicating with a spaceborne satellite 130 and other airborne aircraft 135, according to an embodiment. As illustrated, the system 105 includes processing circuitry 110 (e.g., a processor, graphics processing unit (GPU), etc.), working memory 115 (e.g., volatile or non-volatile random access memory (RAM)), and storage 120 (e.g., non-volatile solid state storage, hard drive, optical drive, etc.). The working memory 115 is configured to hold state information of the system 105 while in operation and is usually reset (e.g., cleared) when power is interrupted or the system 105 is reset (e.g., rebooted). The storage 120 is configured to persist data or instructions between such power or reset events. The storage 120 may also include relevant state information copied from memory 115. The working memory 115 or the storage 120 can include (e.g., store) instructions that, when the processing circuitry 110 is operating, configure the processing circuitry to perform a variety of functions.

The system 105 can include or have an interface to couple to (e.g., control, send or receive commands, etc.) a transceiver 125 configured to communicate with a recipient object, such as the satellite 130. In an example, the transceiver 125 is configured to communicate using photons in one or more frequencies or configurations. For example, the transceiver 125 can operate in radio frequencies. In an example, the transceiver 125 includes multiple antennas to perform beamforming to direct a transmitted or received signal. In an example, the transceiver 125 uses light. In an example, the transceiver 125 uses coherent focused light (e.g., a laser) to produce a beam for transmission.

The system 105 can also include, or have an interface to couple to, other sensors, such as the radar 140. These sensors are configured to make observations of, for example, the satellite 130 or the aircraft 135. Example observations, and thus measurements, can include position, visual information (e.g., an image), reflectivity, etc.

The illustrated scenario involves an intended communication to the satellite 130 and potential interference with the communication by an obstruction or other entity, in this case aircraft 135. The communication may be rerouted using the dynamic routing protocol to avoid the potential interference from the obstruction, in this example. In a variety of equivalent scenarios, the potential interference may include other obstructions instead of or in addition to the aircraft 135, such as another satellite, a balloon, space debris, an aurora, solar rays, etc. or any other object capable of interfering with a communication intended for the satellite 130.

In various examples, the processing circuitry 110 may include quantum computing capabilities. According to various embodiments, the processing circuitry 110 may include a portion of a computing system for executing a dynamic routing protocol. The computing system may include one or more processors (such as processing circuitry 110) and a data storage system (such as the working memory 115 or the storage 120) in communication with the one or more processors, wherein the data storage system comprises instructions thereon that, when executed by the one or more processors, causes the one or more processors to receive data, such as traffic data, network data, routing data, meteorologic data, trajectory data, telemetry data, other related data, or any combination thereof, related to a multipoint communication between a start point and an end point from one or more data sources, calculate one or more routes for the multipoint communication between the start point and the end point using the data and based at least in part on a shortest route between the start point and the end point, optimize, using a quantum processor of the one or more processors, the one or more routes based on the data and a communication status of one or more nodes along the route, dynamically select the optimized one or more routes based timing and performance requirements of the computer system, and execute the multipoint communication between the start point and the end point using the optimized one or more routes.

According to various embodiments, the data may include decrypted data, encrypted data, and metadata including information about the cryptography, such as chosen algorithm, modes, key size, key expiration, or the like. The data may also include ping latency between the start point and the end point, one or more error conditions associated with the route, status of the one or more nodes, telemetry data, an atmospheric or environmental condition along at least a portion of the route, network latency, and/or one or more known delays or outages along at least a portion of the route. The network data may include static or dynamic information regarding at least one of the one or more nodes, such as routers, firewalls, satellites, aircraft, other controller solution, and the like.

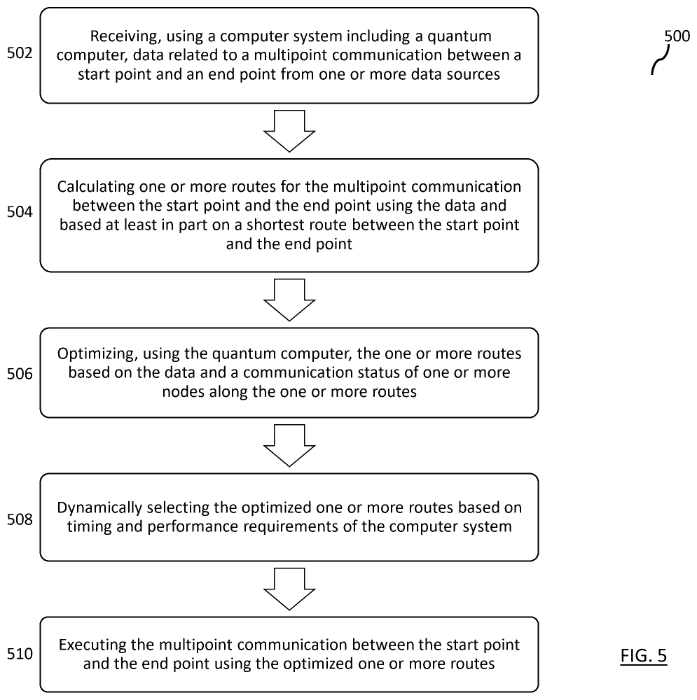

Various embodiments include a non-transitory computer-readable storage medium, the non-transitory computer-readable storage medium including instructions that, when executed by computers, cause the computers to perform operations including the methods of FIG. 5. In various examples, calculating the route includes separating the multipoint communication into segments to be transmitted separately using one or more optimized routes. Optimizing the route includes using machine learning to optimize the route, in some examples. In various examples, the instructions cause the computers to perform further operations of detecting expiration of a time to live (TTL) timer related to the multipoint communication, and upon detection of the expiration of the TTL timer, calculating, optimizing and selecting a second one or more routes for the multipoint communication between the start point and the end point. An optimized route may have a TTL such that as the communication environment changes, e.g., satellites and aircraft move, outages and repairs occur, etc., the usability of the optimized transmission route may be reduced. Using a TTL timer is especially relevant when transmitting large files or messages that will take longer (hours) than smaller files or messages that need less time (seconds) to be completely transmitted.

The subject matter provides quantum enabled dynamic routing protocols. The system may be a quantum implementation on traditional network routes, or further include satellite based dynamic quantum enabled routing protocols. Generally, these protocols are directed to solve the “traveling salesman problem” or optimum route calculation for wireless communications. In various embodiments, the system is configured to calculate shortest routes with the least stops for quantum routing. Currently, routing computations are based on binary computer output, and do not take advantage of quantum computing capabilities. The subject matter uses quantum computing to dynamically optimize routing of wireless communication. In one example, the system uses a probability distribution and a dynamic routing protocol, calculating the shortest route between points or nodes based on numerous variables, and also provides a maximum level of data protection within a calculated shortest path.

In various embodiments, the system may evaluate cryptographic related metadata and ping latency to provide an optimum route for wireless communication. According to various embodiments, the system may use routing data aggregation points, extracting the data to determine a shortest route, and then run a route optimization on a quantum computer to calculate a best path, using near-real time computing to optimize the route. In some examples, using a path or route may affect the status of the path, like a stock purchase effects the stock price. The system takes this effect into account in optimizing traffic. For example, if a message is sent using a first path, a subsequent message may be sent using a second path to avoid that previous message.

The subject matter may use a dynamic routing protocol, for example based on a positional relationship or a most secure route (using time to live (TTL) for example). The system solves the problem of inherent issues with static routing tables that are reliant on data that may not be current. In some examples, the system may use a quantum computer that is designed for mission specific functions to determine a shortest route between end points or nodes. The system may use a standard or classical computer to calculate a destination based on a routing table, and then use a quantum computer to determine, from all the routes, the optimal path or paths. The quantum computer may also send the path and information for various routers along the path, such as in the header of the forwarding packet, to pass the packet along the route, to use routers along the route as simple relays, in various examples. In some examples, a cost of the routing may be used to determine the optimum path. A weighting for the routing is also used to weight factors based on importance, security, timing, or the like, in various examples. The system may also use availability of routing, especially for routing through satellites, to be able to weigh in timing and whether the satellite is available. In one example, line of sight to the satellite to be taken into consideration in the determination of the optimum route for communications to or through the satellite. In one example, the system may use an internet protocol (IP) type of communication, such as IPv6 (version six), for communicating data and metadata between routers. Other types of protocols may be used, such as Border Gateway Protocol (BGP), or the like.

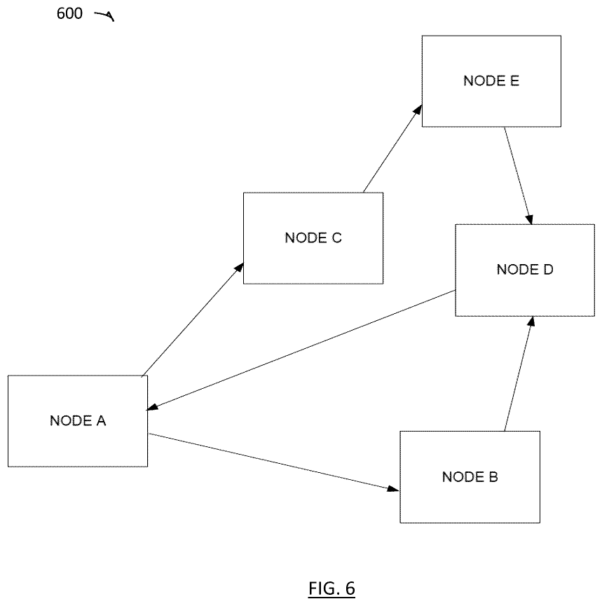

Various types of data may be used to optimize communications, including meteorological data, trajectory data for satellites, debris information to consider line of sight, and the like. In addition, three-dimensional information may be factored by using direct graphs, where these metrics constitute the arc (or directed edge) of nodes such as satellite and ground stations, as shown in FIG. 6. In some examples, IP addresses may be used by the system for sending communications along the optimized route. In other examples, additional methods of indexing satellite routers and relays may be employed. In various examples, the subject matter may use ISO Open Systems Interconnection (ISO OSI) layers. The system may use machine learning to pre-process the routing data, because even when there are not a large number of options for relays or routers in a network, there may be a very large number of weights and variables to consider when optimizing the route. The system may provide for personalized or customized set of weights or variables to be considered, in various examples.

In some examples, the system may use packetizing, or separating a message into chunks and sending the chunks on different paths, and calculating path delay to ensure the message arrives in proper chronological order. The system uses a number of variables, such as traffic and static and dynamic network data, to determine and optimize a routing path for wireless communications. Variables used include, but are not limited to, one or more of ping latency, error conditions, node status, telemetry data, atmospheric or environmental conditions (weather), known delays or outages, network latency, and legal issues (such as legality of examining transport layer security (TLS) encrypted data). The system may aggregate this data and perform calculations using this data, resulting in improved route planning. In some examples, the system may include programmable assurance levels, such as minimum timing, or performance requirements.

The system may be agent or agentless, and may have a central control node, in some examples. In one example, each node may inform or publish to a central location the availability of the node, such as node up or down. The central location may include a hybrid quantum computer setup, that generates a route map based on received data and node availability, and may work in tandem with the quantum computer to define a path using the route map based on programmable assurance levels.

In some examples, one or more satellites, one or more aircraft, or other airborne objects having communication electronics may be included as nodes. However, a satellite may indicate to the central location that it is available but not have line of sight to the central location such that the central location may not receive the indication. In this example, each satellite node communicates with neighboring satellite nodes to cure line of sight problems for other satellite nodes. In another example, the central location knows the orbit of the satellite and can compute availability of the satellite.

Various embodiments include a hybrid quantum and classical route optimization, providing a route optimization using a hybrid calculation that incorporates both a quantum computer and a classical computer. For example, a first route optimization may provide an initial route map based on one or more cost parameters, such as bandwidth. In this example, a quantum computer provides the initial route map and a classical or non-quantum computer decides whether to use the route map based on programmable requirements, such as time limits.

In various embodiments, quantum computing is used to calculate the routes, and artificial intelligence or machine learning (AI/ML) may be used for processing based one environmental conditions. In some embodiments, an AI/ML component augments route forecasting, and may be used to program a quantum computer. For example, the AI/ML may provide recursive learning based on historical performance, such that routing factors may be used for predictive computing, enhancing relevant features and ignoring features that are not predictive of route optimization. Various embodiments use software defined networking (SDN), providing a centralized control function across nodes (satellites), integration with SDNs, and reconfigure routing tables dynamically based on calculations and AI/ML, providing for route optimization. The subject matter may be used for terrestrial or non-terrestrial communications, in various embodiments.

In some examples, the subject matter is used for routing of communications in a mesh network. The mesh network may employ radio communications, quantum techniques such as quantum entanglement, photonic communication, light-based communications (e.g., laser), and the like to communicate securely between the mesh nodes. The use of a mesh network enables communications between nodes in the mesh without requiring line-of-sight when methods of communication such as optical communications are used. In addition, the mesh may generate one or more random bits that may be used, e.g., to generate one or more cryptographic keys that may be used for example in communications.

The formation of the mesh network may begin with the execution of a discovery protocol. This protocol enables nodes to detect the presence of other nodes within their communication range. This may be based upon broadcast discovery messages that are then replied to by nodes that receive the broadcast discovery messages, creating a communication channel between nodes. Nodes may exchange information such as signal strength, various costs associated with the node (such as cost to traverse and cost to use the node), routing information (including routing costs), node capacity, and capability data, including available bandwidth and power resources. This exchange of information allows the mesh network to optimize its topology, ensuring efficient routing of data and distribution of random bits across the network. For example, the nodes may build one or more routing tables using the shared cost information.

To maintain the integrity and robustness of the mesh network, a reconfiguration protocol may be implemented. This protocol monitors the operational status of the nodes and, in the event of a node failure or communication disruption, calculates alternative routes for data transmission. The reconfiguration protocol may utilize a consensus mechanism among neighboring nodes to collaboratively select new routing paths, and may consider factors such as network load, node energy levels, node costs, costs of losing the node to existing links (i.e., the recalculation) and historical reliability data. Example discovery, routing, and maintenance protocols may include Better Approach to Mobile Ad Hoc Networking (BATMAN) and Optimized Link State Routing (OLSR). Both of these protocols enable the self-discovery and self-configuration capabilities that allow mesh networks to function.

In some examples, nodes may exchange routing information. For example, each node may be associated with a cost of traversing and using that node. When a node is lost or a node is discovered—the initial routing and the rerouting algorithms may consider these costs. Further, when there are multiple routes available these costs will be factored in to decide which route to be used.

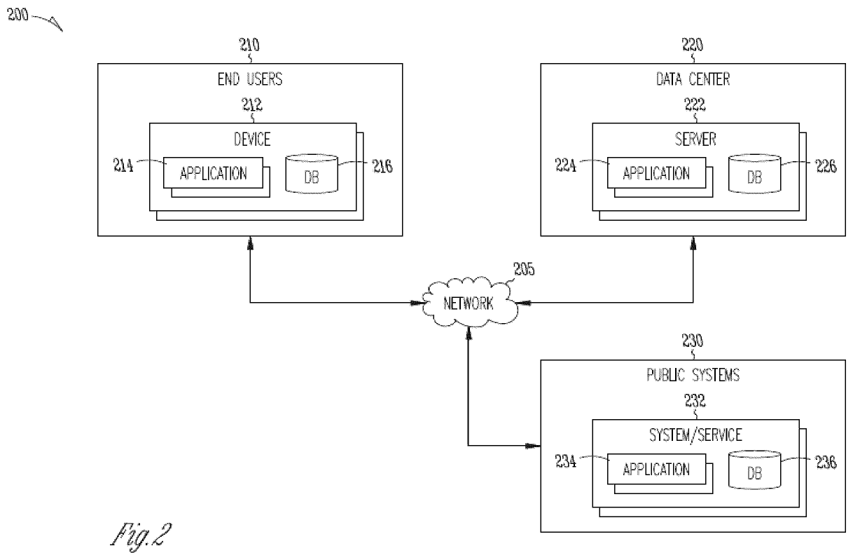

FIG. 2 illustrates an exemplary infrastructure for providing a system of the subject matter. The infrastructure may comprise a distributed system 200 including a computing system that may include a client-server architecture or cloud computing system. Distributed system 200 may have one or more end users 210. An end user 210 may have various computing devices 212, which may be a machine 800 as described below. The end-user computing devices 212 may comprise applications 214 that are either designed to execute in a stand-alone manner, or interact with other applications 214 located on the device 212 or accessible via the network 205. These devices 212 may also comprise databases 216 that hold data locally, the data being potentially accessible by the local applications 214 or by remote applications.

The system 200 may also include one or more data centers 220. A data center 220 may be a server 222 or the like associated with an entity that an end user 210 may interact with. The server 222 or other portions of the distributed system may create and manage the system for dynamic routing protocols, such as by performing operations including the method of FIG. 5, in various embodiments. The entity may be a computer service provider, as may be the case for a cloud services provider, or it may be a consumer product or service provider, such as a financial institution. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 800.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 800.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

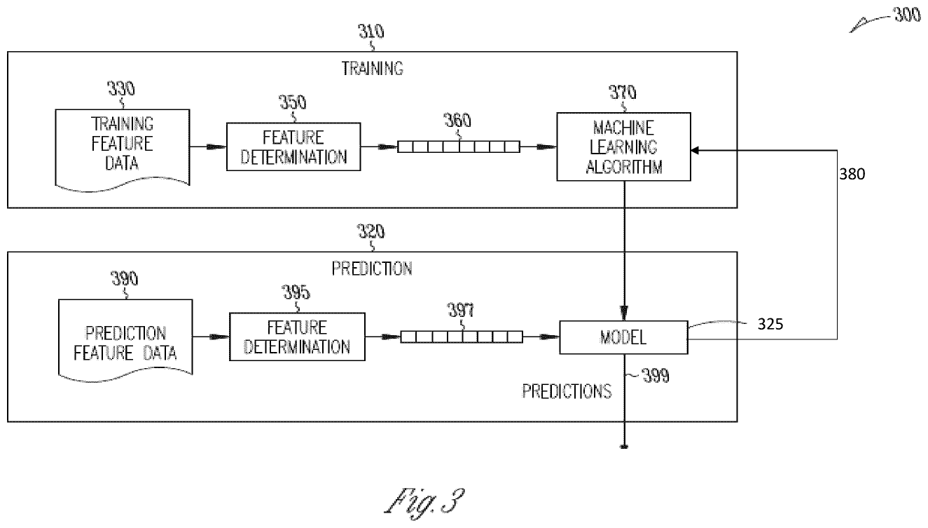

FIG. 3 shows an example machine learning module 300 according to some examples. The machine learning module 300 may be implemented in whole or in part by one or more computing devices. In some examples, the training module 310 may be implemented by a different device than the prediction module 320. In these examples, the model 325 may be created on a first machine and then sent to a second machine. In various examples, the machine learning module 300 may be used generally for dynamic routing protocols.

Machine learning module 300 utilizes a training module 310 and a prediction module 320. Training module 310 inputs training feature data 330 into feature determination module 350. The training feature data 330 may include data determined to be predictive of one or more of determining or optimizing dynamic routing protocols. Categories of training feature data may include policy data, environmental data, user portfolio data, tracked user data, input user data, security data, regulatory data, other third-party data, or the like. Specific training feature data and prediction feature data 390 may include, for example one or more of: current tracked route data, past tracked route data, and the like.

Feature determination module 350 selects training vector 360 from the training feature data 330. The selected data may fill training vector 360 and comprises a set of the training feature data that is determined to be predictive of dynamic routing protocols. In some examples, the tasks performed by the feature determination module 350 may be performed by the machine learning algorithm 370 as part of the learning process. Feature determination module 350 may remove one or more features that are not predictive of dynamic routing protocols to train the model 325. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 325. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as determining or optimizing communication routes. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 325 to produce predictions 399. For example, the weightings and/or network structure learned by the training module 310 may be executed on the vector 397 by applying vector 397 to a first layer of the model 325 to produce inputs to a second layer of the model 325, and so on until the prediction 399 is output. As previously noted, other data structures may be used other than a vector (e.g., a matrix).

The training module 310 may operate in an offline manner to train the model 325. The prediction module 320, however, may be designed to operate in an online manner. It should be noted that the model 325 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 325 during operation (e.g., outputs produced by the model in response to inputs) are used to improve the training data, which is then used to generate a newer version of the model. Thus, a feedback loop 380 enables the results obtained by the model to improve the model.

The machine learning algorithm 370 may be selected from among many different potential supervised or unsupervised machine learning algorithms.

Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

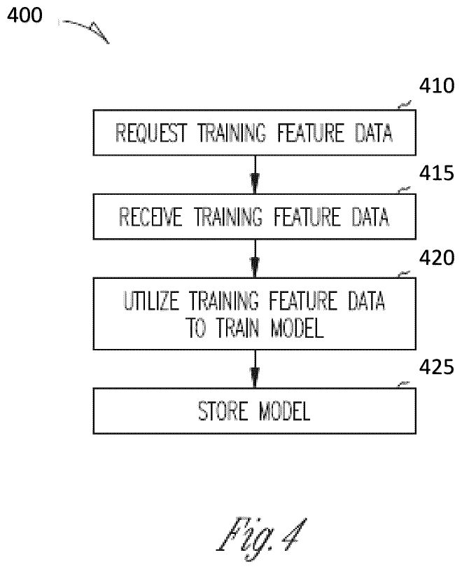

FIG. 4 illustrates a flowchart of a method 400 of updating a model for dynamic routing protocols, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to update the model. For example, by creating a gradient boosted tree, neural network, or the like. At operation 425 the model may be stored in a storage device. In some examples in which the training operations and predictions are done on separate computing devices, the model may be transmitted to a computing device doing predictions. In various examples, the model may be used for one or more of determining or optimizing communication or data transfer routes.

FIG. 5 illustrates an example embodiment of a method for optimizing dynamic routing protocols, according to various embodiments. The computer-implemented method 500 includes receiving, using a computer system including a quantum computer, data related to a multipoint communication between a start point and an end point from one or more data sources, at step 502, and calculating one or more routes for the multipoint communication between the start point and the end point using the data and based at least in part on a shortest route between the start point and the end point, at step 504. At step 506, using a quantum computer, the one or more routes are optimized based on the data and a communication status of one or more nodes along the one or more routes. The communication status may include an indication of availability of the one or more nodes, or other condition of the one or more nodes, in various examples. The optimized one or more routes are dynamically selected based on timing and performance requirements of the computers, at step 508, and the multipoint communication between the start point and the end point is executed using the optimized one or more routes, at step 510.

Optimizing the route includes using machine learning to optimize the one or more routes, in some examples. The machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. In various examples, the artificial intelligence includes a large language model (LLM). Other types of machine learning models may be used without departing from the scope of the subject matter.

FIG. 6 illustrates a block diagram 600 showing a node communication path in accordance with some examples. The block diagram 600 includes a node spanning network of nodes. In some examples, the node network in the block diagram 600 may be a subset of a larger node network (e.g., with entry and exit paths from node A, for example). The node network in the block diagram 600 is fully spanned, meaning a communication may be sent from any node to any other node along the directional edges, although some paths may require more hops than others (e.g., node C to node E uses a single edge, while node B to node E must traverse each of nodes D, A, and C before arrival). Because the edges are directional, a communication may follow a different path from one node to another than it does to return. For example, from node D to A is a direct edge, but from A back to D is either through node B or nodes C and E. The nodes may change geographical position over time (e.g., when representing a satellite or other movable device), or may be static (e.g., a ground station that does not move). The edges may change in connection or direction over time (e.g., in response to environmental conditions, debris, movement of the nodes, etc.). Some aspects, even of moving nodes may be fixed. For example, an IP protocol may be static or dynamic, while typically a country of origin or control may not change or change very rarely.

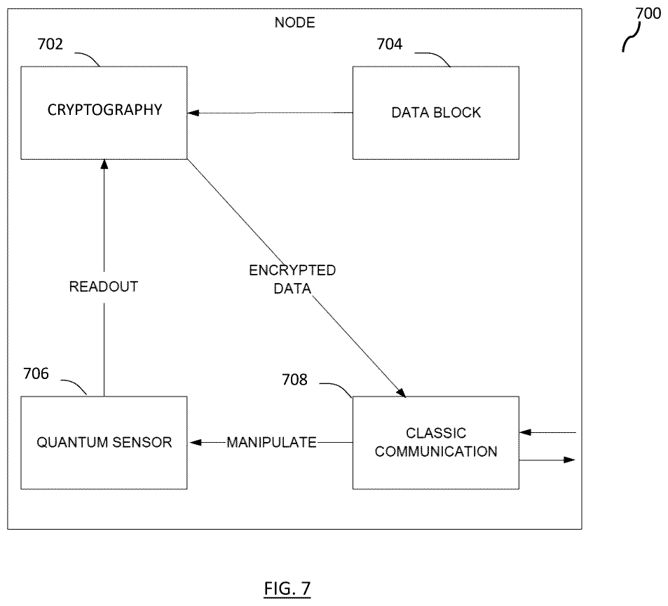

FIG. 7 illustrates example circuitry in a node 700 in accordance with some examples. The node 700 includes circuitry for communication, generation of cryptographic data, quantum data, etc., storage, and processing circuitry. The node 700 may be on a satellite, in some examples. The node 700 shown in FIG. 7 includes cryptographic circuitry 702, which may be used to generate, check, or deduce cryptographic key information. A data block 704 may be used to store cryptographic information, such as a list of one time pads or passwords, previously stored key information, a key generation algorithm, or the like. The node 700 includes classic communication circuitry 708 to communicate off of the node 700. The classic communication circuitry 708 may be used to send a received signal to a quantum sensor 706, which may interpret quantum data (e.g., a paired quantum bit. The quantum sensor 706 may send data related to the quantum data to the cryptographic circuitry 702 (e.g., a readout of entropy, a decimal value of a quantum bit, etc. The cryptographic circuitry 702 may use the data to generate or evaluate a key. A cryptographic key may be used to generate encrypted data (e.g., a message from the data block 704) to the classic communication circuitry 708, which may send the encrypted data to another node.

Each measurement of a quantum entangled particle may produce a random number using any suitable process to quantify the measurement into the random number. In some examples, a stream or multiple instances of a pair of entangled particles may be used to generate the random number with a desired bit length.

In an example, a random number generator of the node 700 (e.g., part of the cryptographic circuitry 702) may produce a random number based on measurements of a quantum derived seed comprising quantum entangled particles, wherein the node 700 measures a first particle in a pair of quantum entangled particles and wherein a second node measures a second particle in the pair of quantum entangled particles. In some examples, by using a pair of entangled particles, a measurement of the first particle at the node 700 may produce the same random number as a separate measurement of the second particle at the second node. This may provide a device for secure communication of random numbers to different nodes in the computing network.

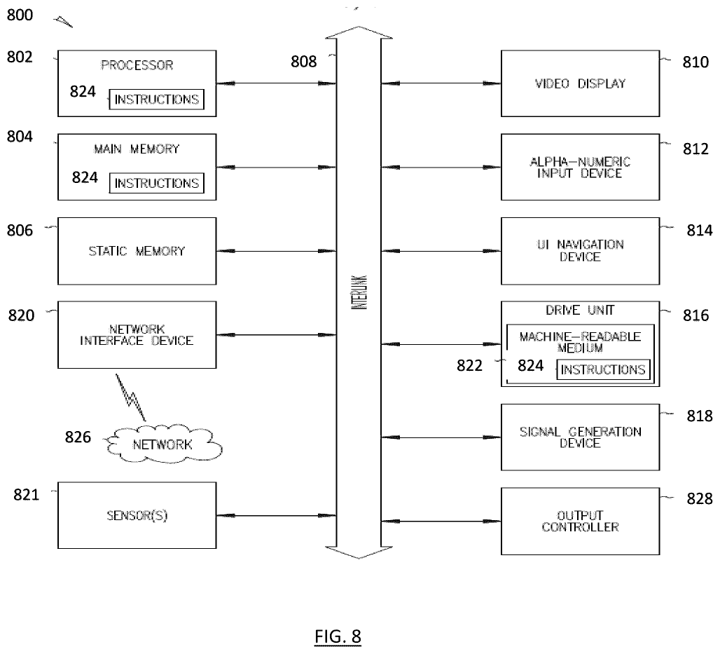

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may implement one or more of the training and prediction modules 310, 320 (e.g., as software or dedicated hardware) and may be configured to perform the methods of FIGS. 4 and 5. The machine 800 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques disclosed herein, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### Other Notes and Examples

Example 1 is a method including receiving, by a computer system including a quantum computer, data related to a multipoint communication between a start point and an end point from one or more data sources, calculating, by the computer system, one or more routes for the multipoint communication between the start point and the end point using the data and based at least in part on a shortest route between the start point and the end point, optimizing, using the quantum computer of the computer system, the one or more routes based on the data and a communication status of one or more nodes along the one or more routes, dynamically selecting, by the computer system, the optimized one or more routes based on timing and performance requirements of the computer system, and executing, by the computer system, the multipoint communication between the start point and the end point using the optimized one or more routes.

In Example 2, the subject matter of Example 1 includes wherein optimizing the one or more routes includes using machine learning to optimize the one or more routes.

In Example 3, the subject matter of Example 2 includes wherein using machine learning includes using a machine learning model including a neural network.

In Example 4, the subject matter of Example 2 includes wherein using machine learning includes using a machine learning model including a long short-term memory (LSTM) network.

In Example 5, the subject matter of Example 2 includes wherein using machine learning includes using a machine learning model including bidirectional encoder representations from transformers (BERT).

In Example 6, the subject matter of Example 2 includes wherein using machine learning includes using a machine learning model including natural language processing (NLP).

In Example 7, the subject matter of Example 2 includes wherein using machine learning includes using a machine learning model including an artificial intelligence (AI)-based knowledge tree.

In Example 8, the subject matter of Example 2 includes wherein using machine learning includes using a machine learning model including a large language model (LLM).

Example 9 is a system including a computing system comprising one or more processors and a data storage system in communication with the one or more processors, wherein the one or more processors includes a quantum computer and wherein the data storage system comprises instructions thereon that, when executed by the one or more processors, causes the one or more processors to: receive data related to a multipoint communication between a start point and an end point from one or more data sources, calculate one or more routes for the multipoint communication between the start point and the end point using the data and based at least in part on a shortest route between the start point and the end point, optimize, using the quantum computer of the one or more processors, the one or more routes based on the data and a communication status of one or more nodes along the one or more routes, dynamically select the optimized one or more routes based on timing and performance requirements of the computer system, and execute the multipoint communication between the start point and the end point using the optimized one or more routes.

In Example 10, the subject matter of Example 9 includes wherein the data includes network data, and the network data includes static information regarding at least one of the one or more nodes.

In Example 11, the subject matter of Example 9 includes wherein the data includes traffic data, and the traffic data includes ping latency between the start point and the end point.

In Example 12, the subject matter of Example 9 includes wherein the data includes network data, and the network data includes dynamic information regarding at least one of the one or more nodes.

In Example 13, the subject matter of Example 9 includes wherein the data includes traffic data, and the traffic data includes status of the one or more nodes, telemetry data, and one or more error conditions associated with the one or more routes.

In Example 14, the subject matter of Example 9 includes wherein the data includes traffic data, and the traffic data includes an atmospheric or environmental condition along at least a portion of the one or more routes.

In Example 15, the subject matter of Example 9 includes wherein the data includes traffic data, and the traffic data includes network latency or outages along at least a portion of the one or more routes.

In Example 16, the subject matter of Example 9 includes wherein the one or more nodes include a router or a firewall or other controller solution.

In Example 17, the subject matter of Example 9 includes wherein the one or more nodes include a satellite or an aircraft.

Example 18 is a non-transitory computer-readable storage medium, the non-transitory computer-readable storage medium including instructions that, when executed by computers including a quantum computer, cause the computers to perform operations of: receiving data related to a multipoint communication between a start point and an end point from one or more data sources, calculating one or more routes for the multipoint communication between the start point and the end point using the data and based at least in part on a shortest route between the start point and the end point, optimizing, using the quantum computer, the one or more routes based on the data and a communication status of one or more nodes along the one or more routes, dynamically selecting the optimized one or more routes based on timing and performance requirements of the computers, and executing the multipoint communication between the start point and the end point using the optimized one or more routes.

In Example 19, the subject matter of Example 18 includes wherein calculating the one or more routes includes separating the multipoint communication into segments to be transmitted separately using the one or more optimized routes.

In Example 20, the subject matter of Example 18 includes wherein optimizing the one or more routes includes using machine learning to optimize the one or more routes.

In Example 21, the subject matter of Example 18 includes wherein the instructions cause the computers to perform further operations of: detecting expiration of a time to live (TTL) timer related to the multipoint communication, and upon detection of the expiration of the TTL timer, calculating, optimizing and selecting a second one or more routes for the multipoint communication between the start point and the end point.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72 (b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method comprising:
receiving, by a computer system including a quantum computer, data related to a multipoint communication between a start point and an end point from one or more data sources;
calculating, by the computer system, one or more routes for the multipoint communication between the start point and the end point using the data and based at least in part on a shortest route between the start point and the end point;
optimizing, using the quantum computer of the computer system, the one or more routes based on the data and a communication status of one or more nodes along the one or more routes;
dynamically selecting, by the computer system, the optimized one or more routes based on timing and performance requirements of the computer system; and
executing, by the computer system, the multipoint communication between the start point and the end point using the optimized one or more routes.

2. The method of claim 1, wherein optimizing the one or more routes includes using machine learning to optimize the one or more routes.

3. The method of claim 2, wherein using machine learning includes using a machine learning model including a neural network.

4. The method of claim 2, wherein using machine learning includes using a machine learning model including a long short-term memory (LSTM) network.

5. The method of claim 2, wherein using machine learning includes using a machine learning model including bidirectional encoder representations from transformers (BERT).

6. The method of claim 2, wherein using machine learning includes using a machine learning model including natural language processing (NLP).

7. The method of claim 2, wherein using machine learning includes using a machine learning model including an artificial intelligence (AI)-based knowledge tree.

8. The method of claim 2, wherein using machine learning includes using a machine learning model including a large language model (LLM).

9. A system comprising:
a computing system comprising one or more processors and a data storage system in communication with the one or more processors, wherein the one or more processors includes a quantum computer and wherein the data storage system comprises instructions thereon that, when executed by the one or more processors, causes the one or more processors to:
receive data related to a multipoint communication between a start point and an end point from one or more data sources;
calculate one or more routes for the multipoint communication between the start point and the end point using the data and based at least in part on a shortest route between the start point and the end point;
optimize, using the quantum computer of the one or more processors, the one or more routes based on the data and a communication status of one or more nodes along the one or more routes;
dynamically select the optimized one or more routes based on timing and performance requirements of the computer system; and
execute the multipoint communication between the start point and the end point using the optimized one or more routes.

10. The system of claim 9, wherein the data includes network data, and the network data includes static information regarding at least one of the one or more nodes.

11. The system of claim 9, wherein the data includes traffic data, and the traffic data includes ping latency between the start point and the end point.

12. The system of claim 9, wherein the data includes network data, and the network data includes dynamic information regarding at least one of the one or more nodes.

13. The system of claim 9, wherein the data includes traffic data, and the traffic data includes status of the one or more nodes, telemetry data, and one or more error conditions associated with the one or more routes.

14. The system of claim 9, wherein the data includes traffic data, and the traffic data includes an atmospheric or environmental condition along at least a portion of the one or more routes.

15. The system of claim 9, wherein the data includes traffic data, and the traffic data includes network latency or outages along at least a portion of the one or more routes.

16. The system of claim 9, wherein the one or more nodes include a router or a firewall or other controller solution.

17. The system of claim 9, wherein the one or more nodes include a satellite or an aircraft.

18. A non-transitory computer-readable storage medium, the non-transitory computer-readable storage medium including instructions that, when executed by computers including a quantum computer, cause the computers to perform operations of:
receiving data related to a multipoint communication between a start point and an end point from one or more data sources;
calculating one or more routes for the multipoint communication between the start point and the end point using the data and based at least in part on a shortest route between the start point and the end point;
optimizing, using the quantum computer, the one or more routes based on the data and a communication status of one or more nodes along the one or more routes;
dynamically selecting the optimized one or more routes based on timing and performance requirements of the computers; and
executing the multipoint communication between the start point and the end point using the optimized one or more routes.

19. The non-transitory computer-readable storage medium of claim 18, wherein calculating the one or more routes includes separating the multipoint communication into segments to be transmitted separately using the one or more optimized routes.

20. The non-transitory computer-readable storage medium of claim 18, wherein optimizing the one or more routes includes using machine learning to optimize the one or more routes.

21. The non-transitory computer-readable storage medium of claim 18, wherein the instructions cause the computers to perform further operations of:
detecting expiration of a time to live (TTL) timer related to the multipoint communication; and
upon detection of the expiration of the TTL timer, calculating, optimizing and selecting a second one or more routes for the multipoint communication between the start point and the end point.
